(19) United States
(12) Patent Application Publication
(10) Pub. No.: US 2012/0179592 A1
(43) Pub. Date: Jul. 12, 2012

(54) FINANCIAL TRADING SYSTEM AND METHOD FOR ENTERING MAXIMUM SIZED ORDERS

(75) Inventor: Adam Sheldon, Chicago, IL (US)

(73) Assignee: Bionic Trader Systems, LLC

(21) Appl. No.: 13/005,520

(22) Filed: Jan. 12, 2011

(51) Int. Cl. G06Q 40/00

(52) U.S. Cl. 705/37

(57) ABSTRACT

A buying power limited financial products order entry system includes or more databases including data identifying currently implemented buying power limits, currently held positions and currently open orders. The system further includes an input command component adapted to receive a command to calculate a maximum order size for a selected financial product based, at least in part, on the currently implemented buying power limits, currently held positions and currently open orders. A method of calculating a maximum order size in a buying power limited financial products order entry system includes the steps of: providing an input command component adapted to receive a command to calculate a maximum order size for a selected financial product; and in response to the command being triggered, calculating a maximum order size for the selected financial product based, at least in part, on currently implemented buying power limits, current open orders and any currently held positions.

### BACKGROUND OF THE INVENTION

The present subject matter relates generally to a financial trading system and method. More specifically, the present invention relates to a financial trading system and method for calculating and entering maximum sized orders.

Financial market traders may place financial orders through trading software. Within trading software, an end user (e.g., trader) is typically given limited buying power. This limited buying power amount can be represented in numerous ways.

For example, if represented as a currency value (i.e., dollar value), the buying power limit may be: the maximum value of a specific contract, position, stock or other instrument that can be held in the account at any one time; the maximum value of any specific contracts or positions or stocks or other instruments that are part of the same exchange that can be held in the account at any one time; the maximum value of all contracts or positions or stocks or other instruments combined in an account that can be held in the account at any one time; or other possibilities. The limited buying power amount expressed as a currency value may be used either on the long side, short side, either or both, depending on the account type and other conditions.

Alternatively, if represented as a number of contracts or shares, this limited buying power amount may be: the maximum number of contracts or shares of a specific contract or position or stock that can be held in the account at any one time; the maximum number of contracts or shares of any specific contracts or positions or stocks that are part of the same exchange that can be held in the account at any one time; the maximum number of contracts or shares of all contracts or positions or stocks combined in an account that can be held in the account at any one time; or other possibilities. The limited buying power amount expressed as a number of contracts or shares may be used either on the long side, short side, either or both, depending on the account type and other conditions.

In addition to the contract level, product level, stock level, exchange level, account level, there may be additional levels to which buying power limits may be assigned. Further, in addition to contracts, positions, and stocks, there may be other instruments to which buying power limits may be assigned.

A trader's buying power or buying power limits are sometimes referred to as risk limits or position limits. These limits may be measured in dollar value, any other currency value, number of contracts or shares or any other value or volume metric. It should also be noted that even if the trader has not hit his buying power limits, he might have an order rejected because the size of that order, if added to the existing position, would be over his buying power limits.

It is intended that the use if the terms buying power and buying power limits encompass any and all of the various iterations of risk limits, position limits and/or buying power limits used now and in the future. Further, it should also be noted that the terms buying power and buying power limits may be used interchangeably as they generally refer to the same concept.

Buying power limits are typically set by the trader's brokerage (often based on the amount of money the trader has in the associated brokerage account) or by the risk manager for the trader's account (often based on the risk manager's assessment of the risk involved in honoring the trader's contracts) in light of the trader's risk profile. The buying power limits are caps on the ability of the trader to execute orders and the limits are typically fixed and remain static over reasonably long periods of time. In accounts where the buying power limits are represented in dollar terms, the buying power limits are typically reset at the beginning of each trading day. In accounts where the buying power limits are represented in number of contracts, the amount is usually not changed unless the brokerage account manager or risk manager makes a manual adjustment.

Typically a financial order entry system allows a trader to select the number of shares (e.g., when dealing with equities) or contracts (e.g., when dealing with futures, options, FOREX, etc.) before submitting an order. For example, if a trader wants to trade 2,000 shares, the trader may input the order size (i.e., 2,000 shares) into the order entry system using a keyboard, mouse or other input mechanism. The trader would then submit the order, again by using an input mechanism. Even though other order entry methods exist, this two-step order entry process is typical; first the trader selects an order size and then submits an order. However, it is understood that in many instances, once an order size has been selected, numerous orders may be placed at the presently selected volume simply by executing additional buy or sell commands.

It should also be noted that the process of submitting an order is not always tied to the process of setting the order size. There are circumstances in which a trader would want to set the order size, and then wait before submitting the order, or possibly even choose to skip the order submission step. As we discuss the process of setting the order size, we may refer to the order submission as part of the same process, as it usually is for most traders. However, this is done for clarity and readability purposes only, and is not intended to infer that the settings of order size and order submission are necessarily tied together.

In instances in which the submitted order size is larger that the trader's buying power limits, the order is typically rejected by the software platform, the brokerage or the exchange.

Often, a trader may want to use the entirety of his or her buying power in executing a trade, whether to go as long as permitted or as short as permitted by the assigned buying power limits Ideally, the trader would like to execute this maximum size order as quickly as possible. The process of executing a maximum size order becomes a three-step process as the trader must first calculate the maximum size order permitted by any or all parties or components involved in the system (i.e., the software platform, the brokerage, the risk manager, the exchange), then assign the order size and lastly submit the order. As will be shown in the examples below, with the understanding that speed or order entry may often be critical, the three-step order entry process may be burdensome; particularly the step of calculating the maximum order size allowed by the parties and/or components involved in the system (software, brokerage, risk manager, and/or exchange).

In futures trading, the number of contracts a trader can hold in the associated account is typically limited by a position limit Less often in futures trading, the number of contracts a trader can hold in the account is limited by the funds in the associated account. Most often the position limit is assigned for each contract desired to be traded, e.g., a position limit for corn, a position limit for crude oil, a position limit for gold, a position limit for a spread between two different calendar months in gold, or similarly any other contract involving commodities, currencies, stock market indices or other contracts. Other times, position limits are assigned at the exchange level, e.g., NYMEX or LIFFE or CME Globex, and still other times position limits are assigned at the account level. Sometimes position limits are assigned only at the contract or product level; sometimes they are assigned only at the exchange level; other times they are assigned at the account level; other times they are assigned at multiple levels within the same account. Because numerous ways in which position limits may be defined and the complexity the definitions may bring, for readability, the discussion herein focuses primarily on position limits being assigned at the contract or product level. When focusing on position limits being assigned at the contract level, i.e., separately for each contract or product, rather than discussing the calculation required for the order to be placed, i.e., the maximum sized order, the positions or open orders for other contracts or products do not affect the calculation. Although the examples provided herein will touch on scenarios in which open orders and positions for other contracts or products affect our maximum sized order calculations, this will be done sparingly, as there are endless levels of complexity and differences in calculation.

It should also be noted that while the discussion of position limits has so far been focused on the context of futures trading, position limits may also be applied to equity trading, FOREX trading, options trading, bond trading or other trading. For example, an equity trader may have a position limit on the number of shares of stock he can hold long or short for a number of different stocks in the account. Accordingly, as used herein the terms contract and product and stock may be used interchangeably as they refer to similar concepts (they are similarly all at a granular level, as opposed to an exchange or account level), which one is more applicable depends on the market or trading venue being considered. However, because of their differences, discussion on one of these terms may be very applicable to all the others, or it may apply only more specifically to the term being used.

Accordingly, focusing on the easier to discuss and less complicated example, calculation of maximum sized orders wherein position limits at the contract level are the limiting factor in a buying power limited account, the maximum order size a trader can execute is the current position limit for the contract on the same size of the market as the intended order minus the current position for the contract minus open orders for the contract on the same side of the market as the intended order, with the current position being represented as a negative number when the current position is on the opposite side of the market as the calculated order size. In one example, the user is holding 5 contracts long and his long position-limit is a position limit of 25 contracts and there are no open orders for the contract on the buy side of the market. As such, the trader is authorized to buy 20 more contracts. However, if the trader also currently has open buy orders in the market, for example a buy order for 3 contracts, then the maximum buy order size is actually 17 contracts. Accordingly, the formula for calculating the maximum buy order size in this example is:

Maximum Buy Order Size=Long Position Limit−Current Position−Open Buy Orders:

Maximum Buy Order Size=25−5−3=17 contracts.

In another example, if the trader is instead currently holding 5 short contracts, rather than 5 long contracts, the maximum buy order size is:

Maximum Buy Order Size=25−(−5)−3=27 contracts.

While both of these examples are simplistic, it can easily be seen that as the number of open orders increases and held contracts increases, particularly in which there are contracts held on opposite sides of the market as the intended order, the complexity of the calculation increases. Aside from complexity in calculation, imagine a scenario where a user had 10 or more open orders and 10 or more positions on a screen. Before the user could even begin the calculation process, the user would first need to visually sort out which of the open positions and open orders needed to be included in the calculation. Further, the calculation becomes even much more complex when we consider possibilities where a user account is limited at the exchange level or account level, for in these situations, currently held positions and open orders for different products will influence the maximum sized order calculation for the produce we wish to calculate a maximum sized order for in complex ways. We will touch on this later on, even though we will do so only lightly for readability.

As a further example, in some instances the trader's buying power limits are provided based on account equity. Note that in comparison to the earlier discussion of how position limits may be assigned at multiple levels (i.e., product, exchange, account, sector, or other levels), when account equity is used, it is typically referred to in the context of the overall account. There are much less common circumstances in which a user account is limited such that a trader may trade with, for example $10,000 worth of one contract or product, $20,000 worth of another contract or product, etc. However this is much less common. Normally when a buying power limited account is limited by account equity, or some leveraged value dependent on account equity, it is typically limited at the account level. It should be noted that account equity may be a number that is fixed at the beginning of every day as is common for equity accounts, or it may vary throughout the day based on profit and loss, as is common for futures and FOREX accounts.

The following is an example of how maximum sized orders may be calculated in a user account limited by account equity. Assume that a trader has $97,447 in account equity and holds no open positions, has no open orders and that the current margin requirement for the contract to be traded is $5,761, how many contracts can the trader buy? In practice, there are two ways to reach the answer: (1) the trader can divide $97,447 by $5,761 and round down to the next integer or (2) the trader can start buying contracts and continue to buy until the orders are rejected (by the software platform, brokerage, exchange or other party). Then, once an order is rejected, the trader can reduce the order size and continue placing orders with smaller quantity until an order is accepted. Neither of these options are optimal solutions, especially considering the value of quick order entry in financial markets trading. In the first case, the calculation may take too long and, in the second case, the market may move while the multiple orders are being placed. For example, even if a trader wasn't sure of an exact number, if he wanted to buy around 30-40 contracts in a market that is not too liquid, as the first contracts are bought (let's assume in lots of five contracts each), the market will sense that someone is starting to bid the market up. As a result, other market participants will usually start buying as well, and this will usually happen before the-discussed trader can finish buying. Even if it just takes a few seconds; that is often too long. Thus, the trader ends up paying a (often significantly) higher price compared to the price had the maximum order size been placed in a single order.

While the examples provided above are on the more simplistic side, calculating the maximum order size can often be much more complex. Take for example, stock trading, rather than futures trading. Like futures trading, the amount of shares of stock a trader can buy or sell may be limited by: the number of shares per stock, long or short, that may be held in the associated account; the number of shares in an overall account, long or short, that may be held in the associated account; the amount of money per stock, long or short, that may be held in the associated account (which must be divided by that stock's price to reach the number of shares); the amount of money in the associated account; the amount of money available for trading in the associated account; or some other cash or margin calculation on the funds associated with the account, often using some sort of leverage calculation (e.g., 10 to 1 intraday leverage, 4 to 1 intraday leverage, 2 to 1 margin leverage, etc.). There are many potential calculations. To further complicate matters, some trading software, brokerages, platforms, etc. will charge clients commissions at the time of the trade. Additionally, there are third party fees that may be incurred. Sometimes futures brokerages charge clients commissions at the time of the trade as well; however it is less common when compared to equity brokerages. As an example of how fees may be implemented for equity trading accounts, a trader trying to buy at the lowest offer on the NYSE Arca exchange, will likely incur charges of, for example, $0.035 per share of stock purchased. Accordingly, 1,000 shares will cost an extra $3.50 to be paid in NYSE Arca exchange fees. Some brokerages and platforms will charge such commissions, exchange fees and other fees after the order, such as at the end of the day or week or even month. But brokerages and platforms may charge such fees at the time of the trade. When the fees are charged at the time of the order, the fees will sometimes be debits against the trader's buying power, thus complicating calculation of maximum sized orders. Further, if a trader's account is leveraged on margin, these calculations may likely need to have a multiple applied to them to assess their real expected impact. In addition to commissions and exchange fees discussed here, there are other fees such as platform fees and data fees which make the calculation of maximum sized orders become more complex. Typically these fees are more to exist for equity trading compared to other trading venues, but may also exist within the context of futures trading, options trading, FOREX trading, bond trading and other trading venues.

Aside from all of these fees, there are also times when traders want to trade in round lots (lots of 100, or share sizes that end in “00”) as opposed to odd lots (with share sizes not rounded off to 100). When a trader wants to trade a maximum sized round lot order, the calculation becomes even more complex.

As can be easily appreciated, the calculations needed to account for round lot orders, brokerage charges, platform charges, commissions, exchange fees, data fees, etc. can quickly complicate the maximum order size calculation. Accordingly, there is a need for systems and methods for efficiently calculating maximum sized orders. In addition, there is a need for systems and methods in which maximum sized orders may be efficiently calculated and placed.

### BRIEF SUMMARY OF THE INVENTION

The subject matter described herein provides systems and methods for efficiently calculating and/or entering maximum sized orders. Enabling the efficient calculation and entry of maximum sized orders may shorten task time, limit errors and reduce risk in executing order entry, and may increase trader profitability.

As used herein, “maximum order size” is defined as the maximum quantity of a given financial instrument (e.g., futures contracts, Option C 606 ontracts, equity shares, etc.) that can be used as the volume (quantity) for an order (e.g., buy or buy to cover order to be placed at the current time or in the future, sell or sell to short order to be placed at the current time or in the future, etc.), such that the order will successfully pass through an order entry system, a risk department, a brokerage and an exchange without rejection or cancellation by the order entry system, risk department, brokerage or exchange.

As used herein, “rounded maximum order size” is the maximum order size rounded down to the next smallest order size that meets conditions prescribed by the user, brokerage, risk manager, exchange or other party. For example, a maximum order size of 312 subject to the prescription that the order must be made in round lots of 100 is a rounded maximum order size of 300. As used herein, rounded maximum order size is a subset of maximum order size. In other words, the term maximum order size includes all kinds of maximum order sizes, including rounded or otherwise limited or adjusted maximum order sizes.

As used herein, “financial product” is defined to include any type of tradable financial instrument. The term financial product includes futures trading instruments (such as contracts), options trading instruments (such as contracts), equities trading instruments (such as stocks), FOREX trading instruments (such as contracts), bond trading instruments (such as contracts), and any other tradable financial instrument.

In some examples of the systems and methods described herein, the subject matter provided herein enables automated calculation of maximum sized orders. In other examples, the subject matter provided herein enables automated calculation and entry of maximum sized orders. In yet other examples, the subject matter provided herein enables the automated calculation and entry of maximum sized orders via a single user action.

One contemplated example of a user-directed financial products order entry system includes data identifying currently implemented buying power limits, current open orders and currently held positions, and an input component, wherein the receipt of an input command calculates a maximum order size for a selected financial product based, at least in part, on the currently implemented buying power limits, current open orders and any currently held positions.

In another contemplated example of a method of calculating a maximum order size in a buying power limited financial products order entry system, the method includes the steps of: providing, within the buying power limited financial products order entry system, an input component to calculate a maximum order size for a selected financial product; and in response to an input command being triggered, calculating a maximum order size for the selected financial product based, at least in part, on currently implemented buying power limits, current open orders and any currently held positions.

In one contemplated example of computer readable media including computer-executable instructions for calculating a maximum order size in a buying power limited financial products order entry system, the computer-executable instructions causing a system to perform the steps of: providing, within the buying power limited financial products order entry system, an input component to calculate a maximum order size for a selected financial product; and in response to an input command being triggered, calculating a maximum order size for the selected financial product based, at least in part, using currently implemented buying power limits, current open orders and any currently held positions.

There are many types of orders that may be used in financial market trading. Some of the most common orders are market orders, limit orders, stop orders, and stop limit orders. Many other order types have been developed over the last few decades, and the number of order types will likely continue to expand into the future. Some of the more recent additions have been bracket orders, OSO orders, OCO orders, timed orders, VWAP orders and many more. Aside from the orders themselves, many order types may be sent with certain qualifiers or conditions. Some conditions placed on orders are “all or none” or “icebergs”. In the invention discussed herein, a maximum sized order may be any of the discussed order types or any other order type currently available now or to be made available in the future. Further, a maximum sized order may contain any of the qualifiers or conditions discussed here or any other qualifiers or conditions currently available now or to be made available in the future.

The above examples of maximum sized order calculations refer to buying power limits, open positions and open orders as variables used in the calculations. There exist numerous other factors that may need to be accounted for within the calculation of maximum sized orders. Some potential factors include brokerage fees, exchange fees, software or other provider fees, fees by exchanges for taking liquidity from market; rebates by exchanges for providing liquidity to market, SEC fees and other fees by government organizations, as well as any other potential fees or rebates, as well as any account adjustments such as wire transfers or other credits or debits or other account adjustments, that may affect the position size a trader may trade within the account. There are additionally other potential factors which may need to be taken account for maximum sized order calculations. It is expected to be understood that all of these potential factors, even if not explained in as much detail as other required components of the formula for maximum sized orders, may or may not play a role in the calculation of maximum sized orders as well. Sometimes, many or all of these fees, rebates and account adjustments, if they exist, are implemented before buying power limits are calculated and implemented, and are therefore already assumed to be taken into account and are not necessary to consider. Other times, these same fees may occur during the trading day; however, as long as they don't affect a current order or cause the potential for margin calls, and only affect future buying power limits, then they can usually be ignored as part of a current maximum sized order calculations. Other times, however, some of these fees, rebates and account adjustments, if they exist, are charged, rebated or implemented at the time of the trade, or otherwise during the trading day, in ways that they have not yet been factored into buying power limits, and therefore, may in fact impact the calculation of maximum sized orders. It is expected to be understood that if any fees, rebates or account adjustments exist which have not been applied already towards buying power limits, may need to be included within the calculation of maximum sized orders. It expected to be understood that potential factors that may be considered to be credits to a user account may need to be added to the formula for maximum sized orders. Likewise, potential factors that may be considered to be debits from a user account may need to be subtracted from the formula for maximum sized orders. Additionally, if a user account is leveraged, a leverage factor may need to be applied within the formula for maximum sized orders as well, usually directly to the potential factor to be included in the formula.

It is understood that some financial products order entry platforms do not allow a trader to cross over from short to long positions or long to short positions in a single transaction. Accordingly, it is contemplated that in some embodiments of the systems and method provided herein, the execution of the maximum size order entry may include a first order to return the user's position to a neutral position (e.g., sell/liquidate long contracts held before selling to maximum short position, or buy to cover/liquidate short contracts held before buying to a maximum long position) and a second order to enter into the maximum long or short position. It is contemplated that in some embodiments of the present subject matter, the execution of the calculation and the execution of the two order entry steps may all be accomplished via a single user action.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram of a financial products order entry system including maximum order size calculation and order entry functionality and the context within which it may be used.

FIG. 2 is a flow chart illustrating a method of calculating a maximum order size for a selected financial product.

FIG. 3 is a flow chart illustrating a method of calculating and executing a maximum order size for a selected financial product.

FIG. 4A is a screen shot of an example of maximum order size order entry screen.

FIG. 4B is a screen shot of an example of maximum order size order entry screen.

FIG. 5 is a screen shot of another example of a maximum order size entry screen.

FIG. 6 is a screen shot of an example of an order resolution selection screen.

### DETAILED DESCRIPTION OF THE INVENTION

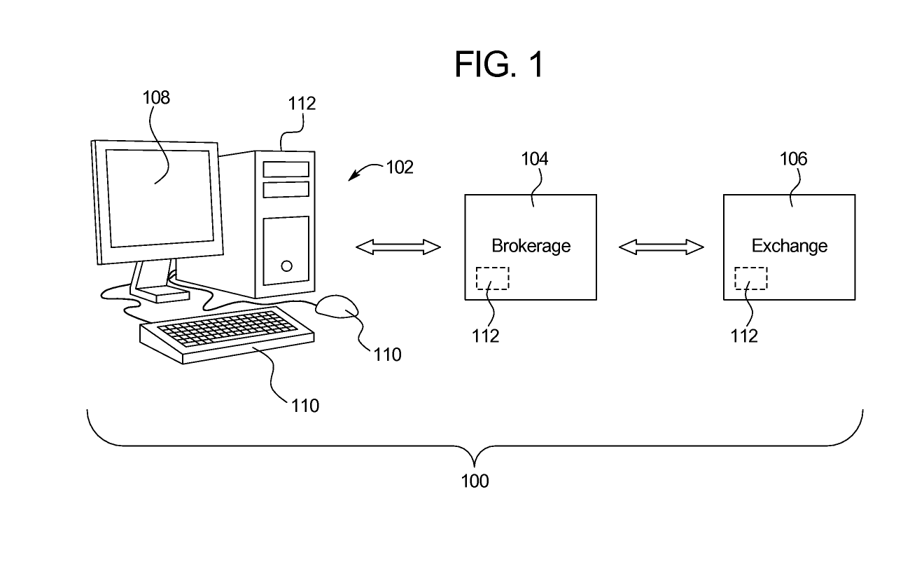

FIG. 1 illustrates a financial products order entry system 100 including a user interface 102 adapted to place orders through a brokerage 104 to an exchange 106. As shown in FIG. 1, the user interface 102 includes one or more displays 108 and one or more user input mechanisms 110, through which a user may interact with the financial products order entry system 100 to place orders. The financial products order entry system 100 shown in FIG. 1 is particularly adapted for efficiently calculating and/or entering maximum sized orders for financial products in a buying power limited account.

Aspects of the financial products order entry system 100 shown in FIG. 1 are controlled by one or more controllers 112. The one or more controllers 112 may run a variety of application programs, may access and store data, including accessing and storing data in associated databases, and may enable one or more interactions via the display 108 and user input mechanism 110. Typically, the one or more controllers 112 are implemented by one or more programmable data processing devices. The hardware elements operating systems and programming languages of such devices are conventional in nature, and it is presumed that those skilled in the art are adequately familiar therewith.

For example, the one or more controllers 112 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories may include a main memory, such as a dynamic random access memory (DRAM) and cache, as well as a read only memory, such as a PROM, an EPROM, a FLASH-EPROM, or the like. The system may also include mass storage devices such as various solid-state drives, disk drives, tape drives, etc. In operation, the main memory may store at least portions of instructions for execution by the CPU and data for processing in accord with the executed instructions.

The one or more controllers 112 may also include one or more input/output interfaces for communications with one or more processing systems. Although not shown, one or more such interfaces may enable communications via a network, e.g., to enable sending and receiving instructions electronically. The physical communication links may be wired or wireless. For example, these links may be used to communicate with a brokerage 104 and/or exchange 106.

The one or more controllers 112 may further include appropriate input/output ports for interconnection with the one or more displays 108 (e.g., monitors, printers, etc.) and the one or more input mechanisms 110 (e.g., keyboard, mouse, voice, touch, bioelectric devices, magnetic reader, RFID reader, barcode reader, etc.). For example, the one or more controllers 112 may include or be connected to a graphics subsystem to drive the display 16. The links to the peripherals may be wired or wireless connections.

Although summarized above as a PC-type implementation, those skilled in the art will recognize that the one or more controllers 112 also encompasses systems such as host computers, servers, workstations, network terminals, and the like. In fact, the use of the term controller 112 is intended to represent a broad category of components that are well known in the art.

Aspects of the financial products order entry system 100 encompass hardware and software for controlling the relevant functions. Software may take the form of code or executable instructions for causing a controller 112 or other programmable equipment to perform the relevant steps, where the code or instructions are carried by or otherwise embodied in a medium readable by the controller 112 or other machine. Instructions or code for implementing such operations may be in the form of computer instruction in any form (e.g., source code, object code, interpreted code, etc.) stored in or carried by any readable medium.

The brokerage 104 shown in FIG. 1 is a financial institution, which in many instances acts as an intermediary between the user interface 102 and the exchange 106. Brokerages take many forms, but with respect to the financial products order entry system 100 described with reference to FIG. 1, one of the key elements of the brokerage is the assignment and application of buying power limits to the user's account. The buying power limits may be assigned by a risk manager or other person whose duties include assigning buying power limits, via automated systems or through a combination of human and automated systems.

It is understood that the example of a financial products order entry system 100 shown in FIG. 1 includes a brokerage 104 as an intermediary between the user and the exchange 106. However, it is understood that other embodiments of the financial products order entry system 100 may not include a brokerage 104 and that the buying power limitations may be provided by the user, the user interface 102, the exchange 106 or elsewhere. Such a scenario could reflect an environment in which a trader or firm sends orders directly to an exchange. In such a system, the trader or firm may still have a relationship with a brokerage, and as part of this relationship it may be agreed upon that the trader or firm will not exceed certain position limits or other buying power limits as agreed upon together or as assigned by the brokerage. However, in this scenario the brokerage does not stand in between the trader or firm and the exchange when it comes to order routing. Such a scenario is typical where speed and stability are crucial. In this type of situation where a trader or firm sends orders directly to an exchange, or in other contemplated scenarios where a trader or firm sends orders that may go elsewhere before reaching an exchange but without the brokerage as part of the order routing process, maximum sized orders are still able to be calculated in various ways. Further, in still other examples there may be no involvement by a brokerage or a relationship outside of the current context.

The exchange 106 shown in FIG. 1 is a forum where tradable securities, commodities, currencies, futures, and options contracts are bought and sold. For example, the exchange 106 may be a stock exchange, securities exchange, commodity exchange, futures exchange, foreign exchange market, etc. It is understood that the exchange 106 shown in FIG. 1 may be any forum in which financial products are bought and sold.

Using the financial products order entry system 100 shown in FIG. 1, a user may calculate and/or execute a maximum sized order for a selected financial product based, at least in part, on the currently implemented buying power limits, currently held positions and currently open orders. To this end, the financial products order entry system 100 may include data identifying currently implemented buying power limits, currently held positions and currently open orders. This information may be generated and/or stored in the user interface 102, the brokerage 104, the exchange 106 or any combination of the three. For example, in one embodiment, the data may be updated and stored at predetermined intervals or continuously within the financial products order entry system 100 and accessed when required. Further, because the data required to calculate and/or execute a maximum sized order for a selected financial product changes or evolves over time, the required data may be generated in response to a user command and may not be stored at all or may not be stored other than as required to perform the generation and calculation steps.

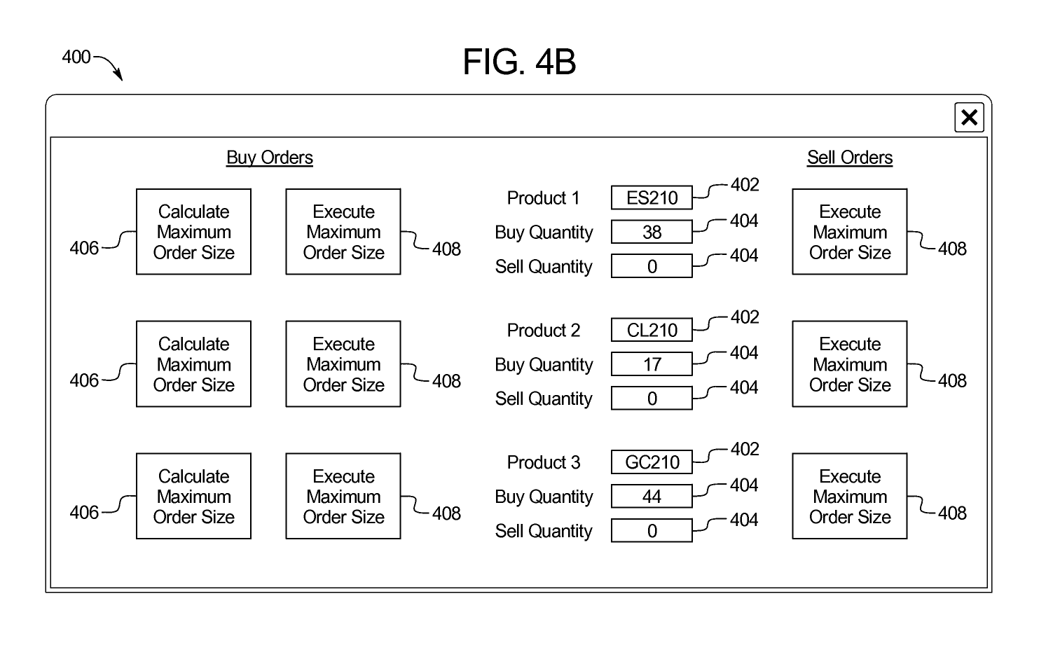

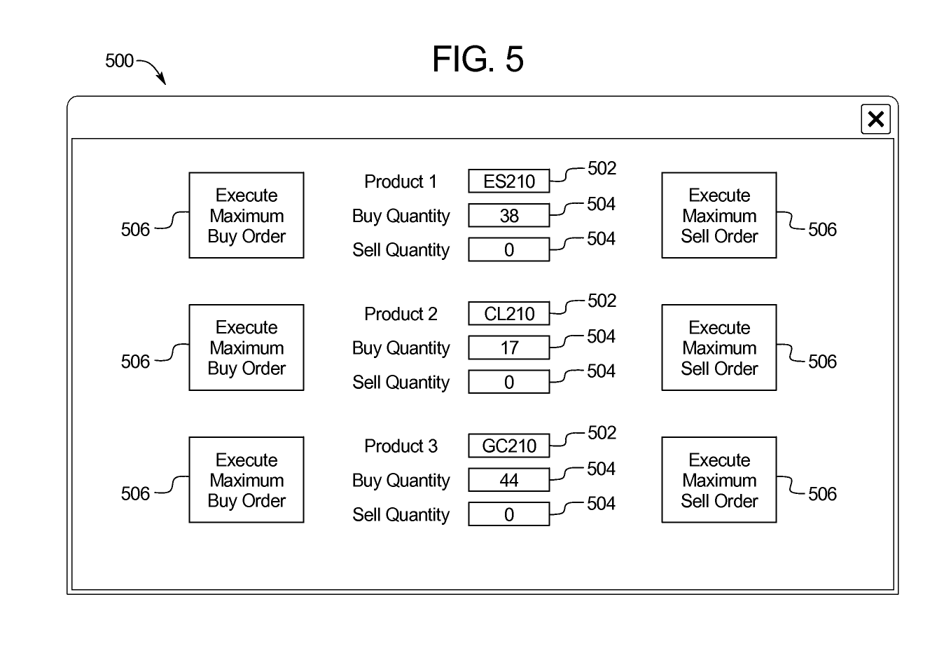

Further, to calculate and/or execute a maximum sized order for a selected financial product, the financial products order entry system 100 may include an input component (for example, as shown in FIGS. 4A, 4B, and 5) through which a user may calculate and/or execute the necessary commands. For example, through the input component, a user may trigger the financial products order entry system 100 to calculate a maximum order size for a selected financial product. The calculation of the maximum order size for the selected financial product may be based, in part, on the currently implemented buying power limits, current open orders and any currently held positions.

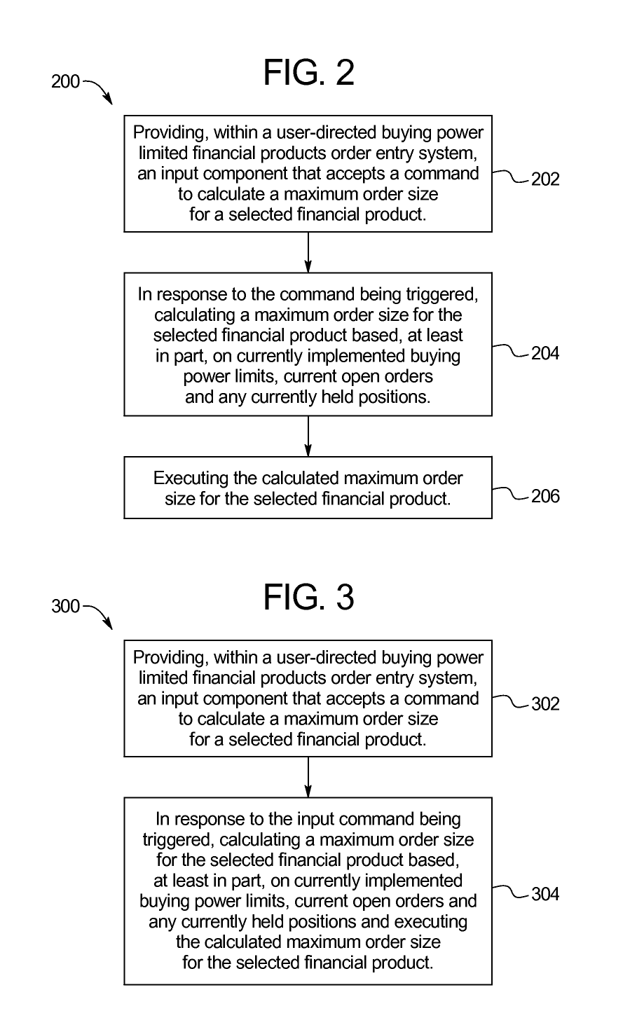

For example, as shown in FIG. 2, the method 200 of calculating a maximum order size in a buying power limited financial products order entry system 100 may include a first step 202 of providing, within the buying power limited financial products order entry system 100, an input component that accepts a command to calculate a maximum order size for a selected financial product. As further shown, the method 200 of calculating a maximum order size in a buying power limited financial products order entry system 100 may include a second step 204 of, in response to the input component being triggered, calculating a maximum order size for the selected financial product based, at least in part, on currently implemented buying power limits, current open orders and any currently held positions. As further shown in FIG. 2, the method 200 may include an optional third step 206 of executing the calculated maximum order size for the selected financial product.

In another example, through the input component, a user may trigger the financial products order entry system 100 to calculate and execute a maximum order size for a selected financial product upon receipt of a single input command. Again, the calculation of the maximum order size for the selected financial product may be based, in part, on the currently implemented buying power limits, current open orders and any currently held positions.

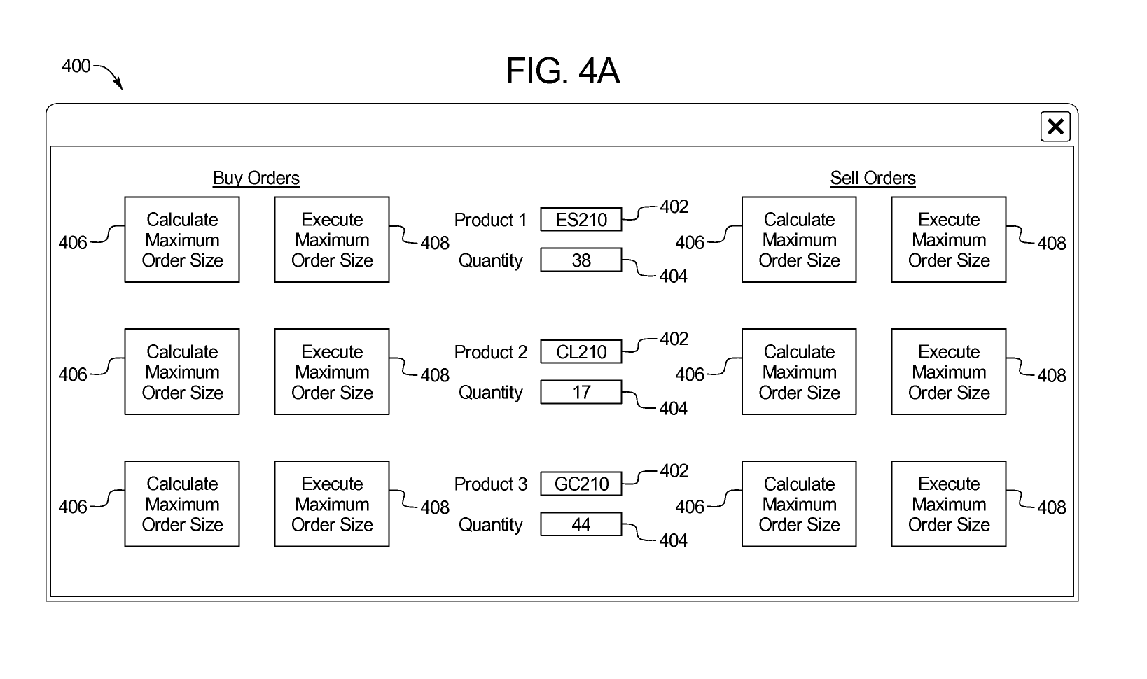

For example, as shown in FIG. 3, the method 300 of calculating and executing a maximum order size in a buying power limited financial products order entry system 100 may include a first step 302 of providing, within the buying power limited financial products order entry system 100, an input component to calculate a maximum order size for a selected financial product. As further shown, the method 300 of calculating a maximum order size in a buying power limited financial products order entry system 100 may include a second step 304 of, in response to the input command being triggered, calculating a maximum order size for the selected financial product based, at least in part, on currently implemented buying power limits current open orders and any currently held positions and executing the calculated maximum order size for the selected financial product.

FIG. 4A illustrates an example of an input component 400 as described above with respect to FIGS. 1-3. The input component 400 shown in FIG. 4 includes separate commands for calculation and execution of maximum sized orders. As shown in FIG. 4, the input component 400 includes three separate product selection inputs 402 through which a user can select three products for which to place orders. It is understood that the number of individual products that may be selected in a given input component 400 is a matter of design choice, it may be as few as one product and as many as can reasonably be included in a given input component 400. In the example shown, the most recently calculated maximum order size is shown in the order size display 404. However, it is contemplated that in various alternative embodiments, the order size display 404 may be available to show any one or more order quantities, including presently calculated maximum sized order quantity or any other quantity.

As shown, the order size display 404 may display the maximum order size for either the buy or sell side of the market. Alternatively, it may be adapted to display the maximum order size on both sides of the market. By viewing the order size display 404 after calculating a maximum sized order, a user can quickly identify the quantity of contracts or shares of any financial instrument that may be bought or sold within the order entry system 100.

In the example shown in FIGS. 4A, there are separate commands to calculate maximum sized buy orders and maximum sized sell orders. In other embodiments, such as that shown in FIG. 4B, the calculation of maximum sized buy order quantity and the maximum sized sell order quantity may be triggered for simultaneous calculation, or calculation in rapid succession, using a single command. Such an embodiment may be particularly advantageous when using a programmable keyboard where only one physical key is needed to calculate maximum order sizes for both buy and sell orders.

As shown in FIGS. 4A and 4B, the input command component 400 includes a calculate maximum order size command 406 for each respective product. In FIG. 4A, there is a separate calculate maximum order size command 406 for each side of the market, while in FIG. 4B, there is a single calculate maximum order size command 406 command for both sides of the market. The calculate maximum order size command 406 is used to calculate the maximum size order for the associated product in response to the users input of the command. Accordingly, providing the input command component 400 including the calculate maximum order size command 406 may be used to accomplish the first step 202 of providing, within the buying power limited financial products order entry system 100, an input command to calculate a maximum order size for a selected financial product, as illustrated in FIG. 2.

After the execution of the calculate maximum order size command 406 is executed, the calculated maximum order size will then be shown in the order size display 404, either on either or both of the buy and sell sides of the market. Accordingly, the calculate maximum order size command 406 may be used to accomplish the first step 202 of providing, within the buying power limited financial products order entry system 100, an input component that accepts a command to calculate a maximum order size for a selected financial product, as illustrated in FIG. 2.

As further shown in FIGS. 4A and 4B, the input component 400 includes an execute maximum order size command 408 for each side of the market, enabling the user to place an order at the calculated maximum size on the desired side of the market. Accordingly, the execute maximum order size command 408 may be used to accomplish the third step 206 of executing the calculated maximum order size for the selected financial product, as illustrated in FIG. 2.

FIG. 5 illustrates another example of an input command component 500 as described above with respect to FIGS. 1-3. The input command component 500 shown in FIG. 5 is adapted for combining the calculation and execution of maximum sized orders into a single input command. Similar to the input command component 400 shown in FIGS. 4A and 4B, the input command component 500 shown in FIG. 5 includes three separate product selection inputs 502 through which a user can select three products for which to place orders, as well as corresponding order size displays 504. The order size display 504 shown in FIG. 5 includes a separate display on the buy and sell sides for each product.

In the example shown in FIG. 5, the order size displays 504 may update in real-time, at predetermined intervals, in response to one or more triggers (e.g., changed market conditions, changed buying power conditions, etc.) or in any other manner. As such, the order size displays 504 functions as a preview for the orders that may be executed by the user. This method of automated calculation of maximum sized orders, whether buy or sell or both, may save users critical thinking time and allow them to focus more on the market. Such a preview function is not contemplated to be limited to embodiments in which the calculate and execute maximum order size functions are combined in a single command. Accordingly, the examples shown in FIGS. 4A and 4B may also incorporate such a preview function, with the calculate maximum order size command 406 acting to ensure the user is seeing the most up to date information in the order size display 404.

Although the embodiments shown in FIGS. 4A, 4B and 5 incorporate order size displays 404 and 504, it is contemplated that alternative embodiments may not provide a view, or preview, of the calculated order size. For example, in such embodiments, a user may submit a financial products order to be executed which contains the quantity of the last calculation of the maximum order size, even though that calculation was never displayed to the user.

As shown in FIG. 5, the input command component 500 includes an execute maximum order size command 506 for each respective product on each side of the market. In response to the activation of one of the execute maximum order size command 506, the products order entry system 100 calculates and executes the maximum sized order on the selected side of the market. Accordingly, providing the input command component 500 including the execute maximum order size command 506 for each respective product on each side of the market may be used to accomplish the first step 302 of providing, within the buying power limited financial products order entry system 100, an input command to calculate a maximum order size for a selected financial product, as illustrated in FIG. 3. Further, the selection of one of the execute maximum order size commands 506 may be used to accomplish the second step 304 of, in response to the input command being performed, calculating a maximum order size for the selected financial product based, at least in part, on currently implemented buying power limits, current open orders and any currently held positions and executing the calculated maximum order size, as illustrated in FIG. 3.

The examples of input command components 400 and 500 shown in FIGS. 4A, 4B and 5, respectively, are merely illustrative examples of input command components 400 and 500 that can be integrated with a financial product order entry system 100. For example, the input command components 400 and 500 shown herein may be integrated within any number of order entry screens or menus. Further, it is understood that the illustrated examples may otherwise be adapted in form and function to integrate with financial product order entry systems 100.

Further, while illustrated as a graphical user interface, it is contemplated that the input command component may be embodied in any form in which a user may trigger either the calculation of, the execution of, or both the calculation and execution of maximum sized orders, including, for example, the use of hot keys, macros, or other user inputs that may not rely on a graphical user interface.

While shown as being separate from the non-maximum size order entry component, the input command components 400 and 500 may be integrated within the remainder of the order entry components. In such embodiments, it may be particularly useful to be able to clear out the calculated maximum order size from the order entry mechanism so as to not accidentally send maximum sized orders to the market. Accordingly, a command may be provided to clear the calculated maximum order size(s) from the financial product order entry system 100 memory and display and/or replace the calculated maximum order size(s) with alternate values.

While the majority of the examples provided herein are directed to the calculation and/or execution of maximum sized orders, it is understood that the systems and methods provided herein may be adapted to provide a user with the ability to execute less than maximum sized financial product orders based on a maximum order size calculation. For example, a user may wish to calculate or execute orders at half the maximum order size (or one-quarter, one-tenth, etc.).

In one related example, the calculation of maximum order sizes may be used to execute financial products orders based on a percentage of the maximum order size. For context, while markets are open, they are almost always in motion. Whether the market is in equities, futures, FOREX, options, or bonds, even a fraction of a second may result in a difference in the calculated value of a maximum sized order. So for example, at 10:00:01, a trader may be able to buy 41 contracts. At 10:00:02, the same trader may only be able to buy 40 contracts. This may be because the user has suffered a loss in the account during the one second period, and that loss is large enough to prohibit the purchase of the one extra contract. Accordingly, it is contemplated that in order to account for rapidly changing conditions that may affect the acceptance of orders based on a maximum order size calculation, users may wish to execute orders of reduced quantity. For example, a user may wish to execute orders that are 95% of the calculated maximum order size, in order to account for variability in relevant conditions and reduce the risk of the order being restricted from execution. Similarly, any other reduced order size may be used. Similarly, users wishing to trade in round lots may use similar functionality to reduce the calculated maximum order size to a rounded lot before execution.

Depending on what the buying power limits are for the long and short sides of the market, there may be situations in which, when a user has a position on a first side of the market, a maximum sized order on the opposite side of the market will merely leave the user with a smaller position on the first side of the market. This scenario may be the result of a the user, risk manager or other party limiting trading on one side of the market or product such that the user cannot completely divest the position on a given side of the market.

By way of example, the following scenarios demonstrate applications of the system 100 and methods 200 and 300 described herein. For a given user account which has its buying power limited by position limits, and in which the position limit is 80 contracts (for both the long and short sides of the market) and the user is currently short 11 contracts, with open buy orders of seven contracts, nine contracts and three contracts (i.e., open buy orders for 19 total contracts), and open sell orders of two contracts and six contracts (i.e., open sell orders for eight total contracts), the calculated maximum buy quantity would be 72 contracts (i.e., 80 minus negative 11 minus 19 equals 72). Under the same scenario, the calculated maximum sell quantity would be 61 contracts (i.e., 80 minus 11 minus eight equals 61).

As can be seen above, when the current position is on the same side of the market it is represented as a positive number in the calculation. When the current position is on the opposite side of the market, it is represented as a negative number in the calculation. In other words, if a current position is on the same side of the market as the order size to be calculated, the current position has the effect of reducing the calculated maximum order size. Conversely, if the current position is on the opposite side of the market as the order size to be calculated, the current position has the effect of increasing the calculated maximum order size.

While the examples provided above assume the allowance by the software, system, exchange, brokerage and any other party involved to allow orders which cross the neutral-line, zero-line, or other named status where a user account would have no position. However, this is not always the case. In such scenarios where the crossing of the neutral-line is not allowed (or otherwise not possible in a single step), the execution of the maximum sized orders may differ from the examples previously discussed. For example, the execution of the order may include a liquidation order followed by an order to initiate a position on the opposite side of the market. It is contemplated that “maximum order size” may refer to the maximum allowed in a single executed order (including any one or more of a plurality of orders executed in succession), the maximum allowed by a combination of multiple executed orders.

In another example, where a user account is limited by long and short position limits at the product level, the user account has a long position limit of 80 contracts for the given product and a short position limit of zero contracts for the product, with a current position of five contracts of the product and no open orders for the product. In this example, the calculated maximum buy quantity for the product would be 75 contracts (i.e., 80 minus five equals 75). The calculated maximum sell quantity for the product would be five contracts (i.e., zero minus negative five equals five).

In yet another example, where a user account is limited by long and short position limits at the product level, the user account has a long position limit of zero contracts for a given product and a short position limit of 80 contracts for the product, with a current position of short five contracts of the product and no open orders for the product. In this example, the calculated maximum buy quantity for the product would be five contracts (i.e., zero minus negative five equals 5). The calculated maximum sell quantity for the product would be 75 contracts (i.e., 80 minus five equals 75).

In a more complex example, a user account may be buying power limited via the application of long and short position limits for the overall account, as well as buying power limited via the application of long and short position limits on specific contracts (products). In this example, the user account has an account level long position limit of zero contracts and an account level short position limit of 80 contracts. Further, the user account has a contract (product) specific long position limit of zero contracts and a contract specific short position limits of 50 contracts. The user holds a current position of short five contracts for the product being discussed and no open orders for the product being discussed. In this example, the calculated maximum buy quantity would be five contracts for the product being discussed (i.e., zero minus negative five equals 5). The calculated maximum sell quantity would be 45 contracts for the product being discussed (i.e., 50 minus five equals 45).

As shown, the formula for calculating the maximum order size, in scenarios where a user account has its buying power limited by position limits, and such that the position limits are given at the contract (or product or stock) level, is simply maximum order size equals the current position limit for the product being discussed on the same size of the market as the intended order minus the current position for the product being discussed minus the open orders for the product being discussed on the same side of the market as the intended order, with the current position being represented as a negative number when the current position is on the opposite side of the market as the calculated order size. Therefore the formula for a maximum sized buy order in scenarios where a user account has its buying power limited by position limits, and such that the position limits are given at the contract (or product or stock) level, is simply maximum sized buy order equals the current long position limit for the product being discussed minus the current position for the product being discussed minus the open buy orders for the product being discussed, with the current position being represented as a negative number when the current position is a short position. Further the formula for a maximum sized sell order in scenarios where a user account has its buying power limited by position limits, and such that the position limits are given at the contract (or product or stock) level, is simply maximum sized sell order equals the current short position limit for the product being discussed minus the current position for the product being discussed minus the open sell orders for the product being discussed, with the current position being represented as a negative number when the current position is a long position.

For purposes of readability, most of the discussion and examples provided herein refer to position limits as the limiting factor in a user account. However, as provided herein, position limits are just one manner in which a user's buying power may be limited on a financial markets trading order entry system 100. Many, although not all, other methods of limiting buying power relate to or are based on currency value (e.g., dollar value) as the limiting factor.

One common method in which a user account may be limited by a currency value is via the use of account equity as the limiting factor. Typically, buying power limits based on account equity may be set based on a factor of the equity to give the user additional leverage during the day. The leverage calculation may be standardized across an industry and governed by an agency, such as is typical with equity trading accounts where there are fairly standardized methods for things like “Pattern Day Trader Buying Power,” which is typically four to one leverage, and “Overnight Margin” and “Intraday Margin” which typically offer closer to two to one leverage, although their exact calculations may involve a large number of variables. In futures, FOREX, and options trading, there is already so much leverage and risk already involved, that typically additional leverage is given less frequently. That said, there are some brokerages that do offer additional leverage, although the method is usually applied manually and is usually dependent on the client's risk profile. It should be noted that all of these possible methods of leverage, or other possible methods of leverage, however applied or not applied, still end up leading to a certain amount of buying power in a user account. All of the methods in which a user account may be limited are considered to be encompassed by the term “buying power limited,” as used herein.

One example where account equity is the limiting factor in a user account, whether or not leverage has being applied to reach this amount or not, is given here. Assume the user account has account equity of $87,555, which in this example, may be used for either the long or short side of the market. Assume that the margin required for each contract currently held and also that is considered for future purchase or sale in this example is $3,785. Assume that the user holds a current position for the product being discussed of short five contracts and no open orders for the product being discussed. In this example, the calculated maximum buy quantity for the product being discussed would be 28 contracts (i.e., $87,555 minus (negative five times $3,785 equals negative $18,925) equals $106,480 divided by $3,785 equals 28.132 rounded down to the next integer equals 28). The calculated maximum sell quantity for the product being discussed would be 18 contracts (i.e., $87,555 minus (five times $3,785 equals $18,925) equals $68,630 divided by $3,785 equals 18.132 rounded down to the next integer equals 18). Note that in this example, all figures were rounded down to the closest integer because partial contracts can not be bought or sold.

In another example, account equity is the limiting factor in a user account, the user is trading equities, and the trader wishes to trade in round-lots of 100. Assume the user account has account equity of $100,000 and the account has margin available of two-to-one. In this example, the buying power limit is $200,000, which in this example, may be used for either the long or short side of the market. Assume that the user wishes to purchase as much of a stock currently trading at $21.26 as possible. The trader currently holds $42,520 worth of the same stock on the long side, and has one open buy order for the same stock for which the buying power used is $17,008. No other open positions for any other products exist in the account, and no other open orders for any other products exist in the account. In this example, the calculated maximum sized buy order quantity for the stock being discussed would be 6,607 shares of stock (i.e., $200,000 minus $42,520 minus $17,008 equals $140,472 divided by $21.26 equals 6607 shares). After rounding down to a round-lot of 100, the rounded maximum sized buy order quantity for the stock being discussed would be 6,600 shares of stock. As shown through this example, it is contemplated that the subject matter disclosed herein may be adapted to provide systems and methods for efficiently calculating and/or entering order sizes based on fractions or percentages of maximum order size.

In another example, account equity is the limiting factor in a user account, the user is trading equities, and the brokerage charges commissions at the time of the trade. No other fees are to be considered in this example although other fees, rebates, and account adjustments may certainly exist. Assume the user account has account equity of $100,000 and the account has margin available of two-to-one. In this example, the buying power limit is $200,000, which in this example, may be used for either the long or short side of the market. Again assume that the user wishes to purchase as much of the stock currently trading at $21.26 as possible. The trader currently holds $42,520 worth of the stock being discussed on the long side, and has one open buy order for the stock being discussed for which the buying power used is $17,008. No other open positions for any other products exist in the account, and no other open orders for any other products exist in the account. Additionally, the brokerage charges a commission of $0.035 per share of stock at the time of the trade. Note how in this example, because the commissions are charged per share, and because the goal of our maximum sized order calculation is specifically a share amount, the formula is more complicated. In fact, an iterative calculation process may be applied to find the exact appropriate maximum sized order calculation. For example, such iterative calculations may be accomplished using the Goal Seek or Solver functions offered in one or more current versions of Microsoft Excel. Using such a tool, the reader may solve for the number of shares of stock that can be purchased for our maximum sized buy order. The methodology used may be one such that cost of the shares plus the cost of commissions are added together by formula, and that the difference between this combined figure (i.e., “the total cost”) and the buying power available is desired to be set to zero. In this case, the buying power available and used in the formula is $200,000 minus $42,520 minus $17,008 equals $140,472. Using the appropriate tools and/or calculations, the number of shares that may be used for our maximum sized buy order may be calculated. It may be noted that, in this example, after rounding down to the nearest integer, the number of shares arrived at through such an iterative or other process to solve for the maximum order size would be 6605 shares of stock. If rounded down to a round-lot of 100, the rounded maximum sized buy order quantity would be 6,600 shares of stock. Note that even though this number is very similar to the prior example, numerous other examples may exist where the inclusion of commissions, fees, rebates or other account adjustments may have a larger impact on the maximum sized order calculation. It is noted that maximum sized order calculations may be arrived at via any iterative processes such as the one described here, or using other iterative processes or other simple or complex processes.

It should also be noted that in the prior example, commissions were charged at the time of the trade, and we have showed how this can increase the complexity of the calculation of maximum sized orders immensely. It is expected to be understood that commissions were just one example of fees; however, as discussed earlier, many other fees are possible to be charged and may have an affect on the maximum sized order calculations. In addition, there may be rebates or other account adjustments which may similarly add complexity to the maximum sized order calculations. Even though detail is not given on all of these possibilities, it is again expected to be understood that the reasoning for this is due to the inherent complexity of the calculations, and in many possible examples, these calculations are complex enough that it is outside the scope of our discussion simply for reasons of readability. It should be noted however, that the existence of all of these possibilities, and that he fact that maximum sized order calculations can be quite difficult, are significant reasons that the disclosed invention is valuable.

As discussed buying power limits may be set in various ways, using position limits, using account equity, or other means. As further discussed, the complexity of calculation for maximum sized orders may be related to the manner in which buying power limits are implemented. When buying power limits are assigned at the contract (or product or stock) level, then the formula for calculating maximum sized orders may manageable enough to be displayed and summarized for the reader, as has been done already in various ways. However, when buying power limits are applied at other levels, such as at the overall account level, then the implications may be significantly more complex, and it is much more difficult to summarize simplistically. A few of these scenarios are addressed in a more detail below.

Under the assumption that a user account is limited at the account level, then if the product for which a maximum sized order needs to be calculated is a different product than a product that has open orders in the account, then depending on methodology in which buying power limits are implemented, the number of contracts contained in the open orders for the other product, or the equity value of the open orders for the other product, may need to be subtracted from the maximum sized order calculation, regardless of whether the open orders are on the same side of the market or on the opposite side of the market. Note that this is in contrast to what is required when position limits or equity limits are assigned at the contract or product level, independent of other contracts or products. Recall in those cases, only open orders on the same side of the market as the maximum sized order to be calculated were considered. However, when buying power limits are assigned at a higher level, such as at an exchange or account level, the formula for maximum sized orders may vary with respect to open orders. What is usually the determining factor in the maximum sized orders formula is whether the open orders that exist, on a different product than the product being considered for a maximum sized order calculation, serve to initiate new positions or whether they serve to liquidate existing positions. Generally, when buying power limits are assigned at a higher level than contract or product (e.g., stock) level, then any open orders for any contracts or products also contained within the same level will need to be considered in the maximum sized order calculation. Generally, any open orders for any contract or product within the same level which are for the initiation of new positions will serve to reduce the size of the maximum sized order calculation, while any open orders for any contract or product within the same level which are for the liquidation of any product in the same level will not have any effect on the formula for maximum sized orders.

As an example, if the user wants to trade SPY from the long side, and currently holds stock long in QQQQ, then if the trader has no open orders on SPY, but does have open orders on QQQQ, then the open orders on QQQQ will serve to reduce the available funds if the open orders on QQQQ serve to increase the existing position size on QQQQ. On the other hand, if the open orders on QQQQ serve to liquidate the existing position on QQQQ, they will have no effect on a maximum sized order calculation for SPY. In the event that the open orders for QQQQ serve to liquidate the existing position on QQQQ, but in addition generate a new position on the opposite side of the market compared to the existing position for QQQQ, then the calculation becomes more complex, and the required calculation for maximum sized orders may or may not be affected, depending on the full size of the open order for QQQQ, as well as the comparison of that size to the size of the current position of the QQQQ.

As an advanced example, if the user holds a long position of 1,000 shares of QQQQ and an open order exists to sell 1,500 shares, this may likely have no effect on the buying power of the account as if the order were filled, the user would have a short position of negative 500 shares, less than the current exposure in the account. However, this is subject to the methods of the brokerage or other party with regards to account policies. Some brokerages may consider this an order for a “boxed position”, in which case the entire order may be applied to reduce the buying power available in the account. If, however, the open order on QQQQ were to sell/short 5,000 shares, then this would surely serve to further limit the buying power of the account, likely by a minimum value of 4,000 shares or the equity value of 4,000 shares, up to a likely maximum value of 5,000 shares or the equity value of 5,000 shares.

It should be noted that with so many different methods that exist for how buying power limits are implemented, it is impossible to discuss every possibility for how maximum order sizes may be calculated. Aside from these inherent complexities, other factors may play a role, such as the specific methodologies of brokerages, risk departments, exchanges and any other firms or parties involved in any of the components of the maximum sized order calculations.

One of the key differences between the different types of markets is the way that transactions are priced. In futures markets, there is typically a margin requirement assigned to each contract. This margin requirement may change from time to time, but may remain static for months or longer. On the other hand, in equities markets for example, the total cost of a transaction is largely based on the number of shares to be purchased multiplied by the cost of each share to be purchased, with also other less significant factors discussed earlier such as commissions and exchange fees. If the buying power limits in a user account are based on position limits, then none of this is significant to the calculation of maximum sized orders. However when buying power limits in a user account are based on account equity or other currency values, then the pricing methods may cause maximum sized order calculations to become complicated. Whether or not the calculation of maximum sized may become complicated has to do with the type of order that is intended to be sent. For instance, if the trader wants to send a limit order, then the maximum sized order calculation is no more challenging than it would otherwise be. However, if the trader wants to send a market order, then the maximum sized order calculation becomes complicated. The reason is that it is not known in advance what price is to be paid for the securities. For this reason, a certain amount of leeway, rounding, or other reduction factor may be appropriate, as was appropriate with our earlier example on when commissions per share would be charged at the time of the trade.

As an example, if the best offer on a stock is $10.00, but the trader wants to buy 10,000 shares, all 10,000 shares may not be available at $10.00. The trader may likely have to pay a higher average price for all of his stock, possibly $10.02 or $10.05. The price that is averaged on the purchase (or sale) above (or below) the best bid or offer (“BBO”) may differ with time of day, liquidity and other factors. Therefore, if our trader only had $100,000 in available buying power, it would be foolish to try and buy 10,000 shares “at the market”, i.e. , via a market order. The order size would have to be reduced for the order to be successfully filled and without being rejected by a brokerage or other party, or possibly worse, creating a margin call. An obvious question is this—how much should the trader reduce his order size by so that it can reasonably be expected to be filled? What kind of tolerance does the trader have for rejected orders? Is it more important for a trader to have larger sized orders go to market, with occasional rejections, or is it more important for a trader to have smaller sized orders go to market, with barely any rejections? As you can see there is a large level of discretion here. Considering the trader doesn't know what the average fill price will be until the order is fully filled, it isn't known exactly how much buying power will be used for a market order. Some brokerages and/or risk managers have their own algorithms for whether to allow or disallow orders based on such scenarios. However, if a trader does not want to risk the possibility of getting orders rejected by a brokerage or risk manager or other party, the trader may wish to set their own methods for reducing a the quantity of maximum sized orders. These methods could be achieved using manual inputs or could be calculated dynamically based on market information. How these calculations are performed and via what means could be a system or method offered by a trading software provider, or by a brokerage or risk manager, or developed or used by the trader, without any assistance from the other mentioned parties.

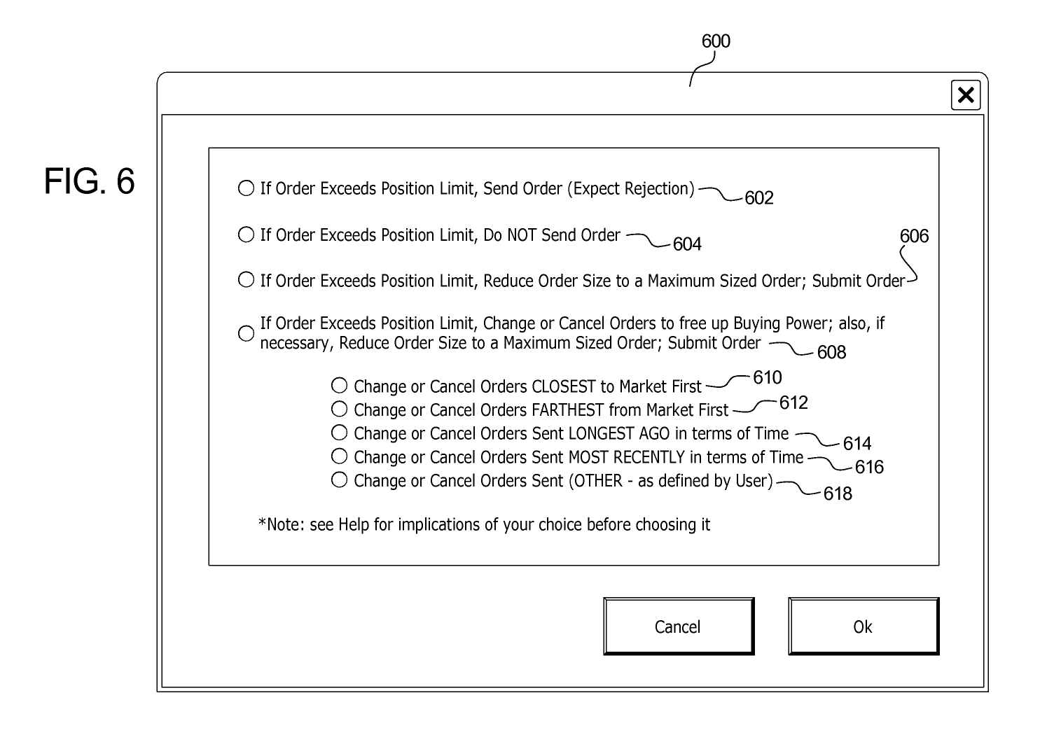

What should be noted again is that exactly how maximum sized orders are approached is flexible. There may simply exist a static approach set up by a brokerage or risk manager or by a trader, or, there may exist this static approach, but on top of that, the trader is allowed to choose settings related to maximum sized orders, thus making the process of adjusting maximum sized order calculations more dynamic. Alternatively, there doesn't need to be a static process defined at all; the trader may set up their own methods for how to calculate and optionally send maximum sized orders. It is contemplated that a user input mechanism, having a relatively light amount of detail, may be provided in order to allow a user to choose settings for how to calculate, optionally adjust and optionally send maximum sized orders. Additionally, or in place of, more advanced settings may be chosen and implemented on specific products or contracts to be traded. It should be noted that while these types of settings may come in handy for any user of maximum sized orders, they may be particularly handy for the more complicated situations. The more complicated situations are typically when account equity or similar currency values are used as buying power limits; also when buying power limits are assigned at a high level, such as at an account level, also when fees, rebates and any account adjustments may be assigned at the time of the trade, also more for equity accounts or possibly Option A 602 counts (discussed further below with reference to FIG. 6) or other accounts in which the cost of transactions are not always knowable in advance.

In one example, a brokerage may have static rules in place such that they only allow market orders to be accepted if there is one half of one percent leeway between the expected fill price of the securities being purchased and the available buying power in the account. The brokerage may keep their methodology quite simple like this, and it may be knowable to the public. Alternatively they may not publish this information but it may be possible to be figured out by the public. The brokerage may or may not vary this methodology based on the liquidity and volatility of the stock. The brokerage may simply use the current bid and offer as the expected fill price, although if the quantity of the order to be submitted is larger than the quantity of stock available at a certain price point, they may make other calculations to estimate the real expected fill price. Many possible methods are possible, and all are included within the context of this discussion here.

Let us assume that the brokerage is also the trading software provider. The brokerage/software provider may give traders flexibility to assign different amounts of leeway for maximum sized order calculations for different stocks (or products), and additional flexibility to assign different amounts of leeway for different order types. One trader using such a system may choose to leave three percent leeway for limit orders, but five percent leeway for market orders, in which the price used in the calculation for market orders is the BBO (best bid or offer). If there is one stock that typically trades very low volume and is illiquid, the trader may wish to assign nine percent leeway for market orders. Via these different potential methods for keeping the maximum sized order calculations flexible and adjustable, users may best adapt the calculations for their own needs. However, it should be noted that this is simply one example, even if a complex one. There are an infinite number of ways in which brokerages, software providers, risk managers, traders, and other parties may interact, as well as what functionality is offered and used by each of the involved parties. At the end of the day, user discretion may play a minimal role or a large role, depending on the system functionality and the goals of the trader or system user.

It should be noted that some trading software and some brokerages or risk departments make available a large number of variables for user account management purposes. Some such variables are available margin or purchasing power. These variables, if available to the user, typically subtract the value of a user's currently held position or “open position” from the user's account equity to arrive at the available margin or purchasing power variables. Similar methods may be available for systems using position limits as well. It is expected to be understood by the reader that even if these or other variables are made available within trading software by a brokerage or other party for use or viewing on the system in general, it does not change the fact that the system is a buying power limited system, and that the process for calculating maximum sized orders is still the same; i.e., “open position” or “currently held position” is still subtracted from the buying power limits of the user account to reach the resulting calculation of maximum sized orders. If there happens to be an intermediate variable or variables within the trading software that makes part of the maximum sized order calculation viewable to the user, such as the subtraction of open position from account equity to reach available margin or purchasing power variables, this has no effect on our formula for maximum sized orders to be implemented. It should be noted that even though what is described here is in the context of account equity, the same is also true in scenarios where position limits are the limiting factor in a buying power limited user account, and where other variables are available for viewing purposes to the user.

Maximum sized orders have been described in quite a bit of detail herein. In some instances, the described processes involve some kind of user command or direction to calculate a maximum sized order. In other examples, the maximum sized order is calculated without user action or as part of a larger process. In addition, as described above, the maximum order size calculation may be implemented as part of a macro.

The following is an example of another process that may involve maximum order size calculation as provided herein. Particularly, the following examples are related to a financial products order entry system 100 including an order resolution component adapted to apply a selected one or more of a plurality of automatic resolution actions when there exists at least one order that, if executed, would result in a condition in which a presently implemented buying power limit is exceeded. For example, a newly submitted order, if executed, may result in a condition in which a presently implemented buying power limit is exceeded. Alternatively, the combination of an existing open order and a newly submitted order, if executed in combination, may result in a condition in which a presently implemented buying power limit is exceeded. Alternatively, evolving conditions may impact the presently implemented buying power limits which may impact existing or newly submitted orders such that, if executed, may result in a condition in which a presently implemented buying power limit is exceeded. Because a buying power limited financial products order entry system 100 will prevent the execution of commands that will result in a condition in which a presently implemented buying power limit is exceeded, the financial products order entry system 100 provided herein is adapted to resolve order and other command conflicts.

For example, the resolution of conflicts may involve the changing of one or more order parameters. Using existing systems and methods, changing an order usually means highlighting a particular order using a mouse or selecting it with a hotkey in some way, and then either changing the price using up/down arrows or hotkeys or by dragging and dropping an order from one location to another on an order window. Canceling an order usually means highlighting or selecting a particular order and then canceling it in some way. Also another option is canceling all open orders at the same time, which still requires a user-action. What is common to all of the existing technology is that each of the response methodologies required for each of these scenarios in today's financial trading software requires these changes, cancellations, and adjustments of order size to be performed manually. These types of processes take time and are nothing but a disruption to traders. Accordingly, using the systems and methods provided herein to address these problems may be beneficial.

When a trader attempts to execute an order that exceeds the user's buying power limits, there are several options for how the conflict may be resolved. An example of an order resolution selection command component 600 is illustrated in FIG. 6. As shown in FIG. 6, the order resolution selection command component 600 provides four options from which a user may select how such order conflicts are resolved.

As discussed herein, the phrase “if order exceeds position limit” is shorthand for any order that, if fulfilled, would exceed the presently implemented buying power limits Depending on the context, an order exceeding position limits may be any order, which when considered in combination with open positions and open orders, would put the trader above the buying power limits

The first option shown in the example provided in FIG. 6 is: if order exceeds position limit, send order (expect rejection) 602. This is the resolution most common in existing trading software. It will be referred to herein as Option A 602.

The second option shown in the example provided in FIG. 6 is: if order exceeds position limit, do not send order 604. No additional explanation is needed for this option. It will be referred to herein as Option B 604.

The third option shown in the example provided in FIG. 6 is: if order exceeds position limit, reduce order size to a maximum size order; submit order 606. In some instances in which a trader has open orders, the trader may not want to cancel or change any existing orders at all; however, the trader may like to change the quantity of their new order to a maximum sized order. It will be referred to herein as Option C 606.

The fourth option shown in the example provided in FIG. 6 is: if order exceeds position limit, change or cancel orders to free up buying power; also, if necessary, reduce order to a maximum sized order; submit order 608. The fourth option 608 includes five sub-options. This option may be used in instances in which a trader may wish to cancel or change existing open orders in the market in order to free up buying power, and then resubmit an order for the same size or a different order size, possibly a maximum sized order to the market. It will be referred to herein as Option D 608.

The first sub-option shown in the example provided in FIG. 6 is: change or cancel orders closest to the market first 610. The second sub-option shown in the example provided in FIG. 6 is: change or cancel orders farthest from the market first 612. The third sub-option shown in the example provided in FIG. 6 is: change or cancel orders sent longest ago in terms of time 614. The fourth sub-option shown in the example provided in FIG. 6 is: change or cancel orders most recently in terms of time 616. The fifth sub-option shown in the example provided in FIG. 6 is: change or cancel orders sent (other—as defined by user) 618.

The following examples are provided to further explain the options offered in the order resolution selection command component 600 illustrated in FIG. 6. In these examples, a trader wants to buy ten e-Mini S&P contracts. The contract is currently bid at 1105.50. The trader believes it is likely he will be able to buy the contracts at a lower price than 1105.50, but decides that if they don't get filled at lower prices, he would like to buy the contracts at higher prices. The trader has a position limit of ten contracts.

Scenario One: (an example of what is common in existing trading platforms):
9:45:00 AM Trader puts in 1 order to buy 2 contracts at 1104.50
9:45:02 AM Trader puts in 1 order to buy 2 contracts at 1103.00
9:45:04 AM Trader puts in 1 order to buy 4 contracts at 1100.00
9:45:30 AM e-Mini S&P starts to move up instead of down. Price is now 1106.25.
9:45:31 AM Trader, either forgetting he has outstanding orders for 8 contracts, not being able to add up his 3 buy orders quick enough to add them to 8 contracts, or for some other reason, puts in a buy order for 4 contracts at the “market.” A “market” order, if accepted, would be filled immediately. However:
9:45:32 AM Order is Rejected by either Platform/Brokerage/Risk Manager/Exchange because trader does not have sufficient buying power available.
9:45:33 AM Trader either cancels one of three existing orders in market or trader reduces size of new order from 4 contracts to 2 contracts. Price is now 1107.00.
9:45:34 AM Trader re-submits new buy order to market. Order filled at 1107.00

Note that in Scenario One, even if at time 9:45:31 the trader remembered there were outstanding orders and the trader wanted to send a new order for 4 contracts, he would still have to manually cancel one of the outstanding orders, manually reduce the size of an outstanding order, or manually reduce the size of the new order. Each of these steps would have taken time.

Now turning to Scenario Two, in which the trader has essentially the same goals as in Scenario One, but under the conditions that the trader has selected Option C 606:
9:45:00 AM Trader puts in 1 order to buy 2 contracts at 1104.50
9:45:02 AM Trader puts in 1 order to buy 2 contracts at 1103.00
9:45:04 AM Trader puts in 1 order to buy 4 contracts at 1100.00
9:45:30 AM e-Mini S&P starts to move up instead of down. Price is now 1106.25.
9:45:31 AM Trader, possibly knowing that there exist outstanding orders for 8 contracts or possibly not caring if they exist or not, puts in a buy order for 4 contracts “at the market”. Because the trader has selected Option C 606, the new order is automatically reduced from 4 contracts to 2 contracts by system. The order is accepted by the platform, brokerage, risk manager and exchange, and order is filled at 1106.50, a 50 cent improvement over Scenario One.
9:45:32 AM (step avoided)
9:45:33 AM (step avoided)
9:45:34 AM (step avoided)

Now consider Scenario Three: in which the trader selects Option D 608:
9:45:00 AM Trader puts in 1 order to buy 2 contracts at 1104.50
9:45:02 AM Trader puts in 1 order to buy 2 contracts at 1103.00
9:45:04 AM Trader puts in 1 order to buy 4 contracts at 1100.00
9:45:30 AM e-Mini S&P starts to move up instead of down. Price is now 1106.25.
9:45:31 AM The trader, possibly knowing there exist outstanding orders for 8 contracts or possibly not caring that they exist or not, puts in a buy order for 4 contracts “at the market”. Because of the selection of Option D 608, one of the existing buy orders is cancelled (which one is cancelled may be based on prioritization, which is discussed further herein); then the new order to buy 4 contracts is sent to market. The order is accepted by the platform, brokerage, risk manager and exchange, and the order is filled at 1106.50, a 50 cent improvement over Scenario One.
9:45:32 AM (step avoided)
9:45:33 AM (step avoided)
9:45:34 AM (step avoided)

The main difference between Scenario Two and Scenario Three is that in Scenario Two, the new order had its own size reduced to stay below the buying power limit, while in Scenario Three, an older order was cancelled to free up buying power.

Now consider Scenario Four in which the trader again selects Option D 608:
9:45:00 AM Trader puts in 1 order to buy 2 contracts at 1104.50
9:45:02 AM Trader puts in 1 order to buy 2 contracts at 1103.00
9:45:04 AM Trader puts in 1 order to buy 4 contracts at 1100.00
9:45:30 AM e-Mini S&P starts to move up instead of down. Price is now 1106.25.
9:45:31 AM Trader, possibly knowing that there exist outstanding orders for 8 contracts or possibly not caring if they exist or not, puts in a buy order for 20 contracts “at the market”. Because of the selection of the Option D 608, all of the open orders are cancelled; then the new order to buy 20 contracts is reduced in size to 10 contracts and sent to market. The order is accepted by the platform, brokerage, risk manager and exchange, and order is filled at 1106.50, a 50 cent improvement over Scenario One.
9:45:32 AM (step avoided)
9:45:33 AM (step avoided)
9:45:34 AM (step avoided)

Note that the only difference between Scenarios Three and Four is that in Scenario Three, the last order did not get reduced in size before being sent to market. In Scenario Four, the last order did get reduced in size to a maximum sized order before begin sent to market.

Let's now consider some specifics and implications of order option selections. Anytime an order is reduced in size, as may occur if Option C 606 or Option D 608 is selected by user, then the new order size will be smaller than originally submitted by user, and will be the largest possible order size that will not be rejected by software or brokerage or risk manager or exchange. It is therefore a maximum sized order.

Let's review Option D 608, and what steps that might occur in a typical trading platform if it were to take the steps that may likely be part of the process:
Step A) Cancel one or more existing orders, based on initial calculation of how much buying power will be freed up by each open order, and based on user choice (or brokerage or other party choice) for how orders are prioritized for cancellation (see choices below Option D 608 in FIG. 8).
Step B) Wait for response from exchange for a confirmation on cancel of existing order(s).
Step C) Calculate new buying power available for use for next order. If not enough contracts had been cancelled successfully so far then repeat Steps A and B. If there are no more orders that may be cancelled, but still buying power available is less than required for current order size attempting to be sent, move to Step D. If enough buying power is available for current order size attempting to be sent, move to Step E.
Step D) Calculate maximum order size; Reduce order size of current order to be a maximum sized order.
Step E) Send order, whether an order of size initially submitted, a maximum sized order, or an order of otherwise adjusted size.

Note that there are potentially large implications for risk if Step B were skipped, i.e., if it were assumed that orders attempted to be cancelled would indeed be cancelled before sending a subsequent maximum sized order.

Although the above discussion focuses on canceling orders, the described methodologies may be applied to changing orders as well. The following are examples of ways in which orders may be prioritized for cancellation and/or change requests:
i. CLOSEST to market in terms of price 610
ii. FARTHEST from market in terms of price 612
iii. LONGEST AGO in terms of time 614
iv. MOST RECENTLY in terms of time 616
v. Other (defined by user, brokerage, risk manager, or other party) 618

Let us now review some of the implications of the order options described above. By providing the trader the ability to apply Options C and D 606 and 608, the trader may replace a manual set of processes with an automated set of processes. As described, Options C and D 606 and 608 invoke the calculation of maximum sized orders when the calculations are necessary, without traders even having to think about it. Further, in Option D 608 traders are given the choice to prioritize new orders over existing orders or to have existing orders changed or cancelled, automatically freeing up buying power for new orders. By offering the Options C and D 606 and 608, traders may skip some very mundane yet very time consuming tasks associated with trading. The more efficient order management process described herein will allow for traders to focus more easily on the market and its signals. One of these mundane tasks that may be avoided is waiting for an exchange response on any cancel requests made as part of Option D. These cancel requests may be included as part of the process for Option D. This way, the trader's new order will be accepted and will not put the trader over the buying power limits

A trader that chooses Option A 602 or Option B 604 may be thinking “if I place an order that attempts to use more buying power than available, I may have made a mental mistake in thinking the buying power was available when really it wasn't. If this scenario occurs, either do not send my new order, or send it to market, and let me get the order rejection I am used to getting—as is typical of most platforms.”

A trader that chooses Option C 606 may be thinking “any orders I have already placed are important to me—more important than any new orders I want to place. Therefore I never want my system to cancel or change my open (existing) orders. However, that said, if I do try to send a new order which would normally be rejected due to its usage of more buying power than is allotted, I do want my system to still recognize my intention to send this large order. Therefore, if not all the buying power is available for use that I initially intended, reduce the order size to a maximum sized order, and submit this maximum sized order.”

A trader that chooses Option D 608 may be thinking “regardless of what my intention was in the past when I placed the orders I did, my intention is now different. Any time I place a new order, the system should assume that it should take this new order as the highest priority. In order to get this new order submitted, I want the system to first see if the order is executable with its current quantity. If not, I want the system to cancel or change any or all old orders (as many as necessary) to free up buying power for the new order. The method in which orders should be prioritized for cancellation should be as I defined in the settings. Further, if changing or cancelling all of the open orders does still not free up enough buying power for my new intended order, then my new intended order should be reduced in size to a maximum sized order, and then this maximum sized order should be submitted to market.”

Options C and D 606 and 608, particularly with regard to the maximum sized orders, may be viewed as follows: in the case that a trader is attempting to send an order to market, wherein the size of the order is too big, given buying power limits and considerations for open positions and open orders, such that the order would get rejected by the software platform, brokerage, risk manager, exchange or other party, then we allow the order quantity of the discussed order to be reduced in quantity to a maximum sized order, and then submitted to market instead of the original order. Note that this essentially encompasses the idea behind Option C 606, but only part of the idea behind Option D 608. To summarize the valuable new methodologies of Option D 608, aside from the referenced maximum sized order calculation, Option D 608 further involves the cancellation or changing, or optionally, prioritized cancellation or changing, of orders existing in the market. For example, such cancellations or changes may occur when a new order with a given size is large enough such that, if the order were entered, the user would be above their buying power limits In such an example, previous orders that had been sent to market may be automatically cancelled or changed, with optional prioritization, making room for the new order. The existing orders that may be changed or cancelled as part of Option D 608 may be any orders in the user account, not only orders for the same product as the new order.

In another example in which Option C 606 is applied in futures trading, a trader has a position limit of 15 contracts for the long side and the short side. Trader has no current position and no open orders. The trader submits an order to buy 20 contracts. Because the order of 20 is greater than the long position limit of 15. If Option C 606 is selected, the order size is automatically adjusted to a maximum sized buy order of 15 contracts and is then submitted to market.

In yet another example the application of Option C 606 in equities trading, the buying power limits are defined by account equity in the account multiplied by four (i.e., the Pattern Day Trader rule). The trader has $100,000 in account equity, which provides an intraday buying power limit of $400,000 and the limit remains constant during the day, regardless of intraday profit/loss fluctuations. The trader has no positions, no open orders, no special margin call situation, and the full $400,000 in buying power available. The trader has configured the system 100 to provide a 3% leeway and to trade in round lots of 100. If the trader submits an order to buy 10,000 shares of stock at a limit price of $50.25, the order will not be accepted due to buying power limits. However, it is calculated that the trader will only be able to purchase 7,960 shares at a fill price of $50.25 and, because of the other settings (i.e., leeway of 3% and round-lots) the order is reduced to 7,700 shares and sent to market.

Assume the exact same conditions as the previous example, except having with Option D 608 applied rather than Option C 606 and further assume that the user has an open order to buy $50,000 worth of stock at the time the new order for 10,000 shares is sent. Because Option D 608 was implemented, the order to buy $50,000 worth of stock is first cancelled. Then, once the confirmation of that cancel is received by software platform, brokerage or other party, the order is reduced from 10,000 shares to 7,700 shares and sent to market.

The methods 200 and 300 shown in FIGS. 2 and 3 may be embodied in computer readable medium, such as, for example, one or more software programs that cause the system 100 to perform the desired methods 200 and 300. As used herein, terms such as computer or machine “readable medium” refer to any medium that participates in providing instructions to a processor for execution. Such a medium may take many forms, including but not limited to, tangible storage media, as well as carrier wave and tangible transmission media. Non-volatile storage media include, for example, optical or magnetic disks, such as any of the storage devices in any computer(s) shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

1-20. (canceled)

21. A buying power limited financial products order entry system comprising:
a calculating component configured to calculate a maximum order size for a selected financial product based, at least in part, on currently implemented buying power limits, currently held positions and currently open orders.

22. The financial products order entry system of claim 21 wherein the calculating component is triggered to calculate a maximum order size by a user command and further wherein the user command triggers the execution of the calculated maximum order size for the selected financial product.

23. The financial products order entry system of claim 21 wherein the calculating component is triggered to calculate a maximum order size by a user command and further wherein a second user command triggers the execution of the calculated maximum order size for the selected financial product.

24. The financial products order entry system of claim 21 wherein the calculating component is triggered to calculate a maximum order size via a user input mechanism.

25. The financial products order entry system of claim 21 wherein the data identifying currently implemented buying power limits is provided, at least in part, by a brokerage.

26. The financial products order entry system of claim 21 wherein the calculating component calculates independent maximum order sizes for buying and selling the selected financial product.

27. The financial products order entry system of claim 21 further including a maximum order size display configured to display the presently calculated maximum order size for the selected financial product.

28. The financial products order entry system of claim 27 wherein the maximum order size display is updated in real-time.

29. The financial products order entry system of claim 27 further including separate maximum order size displays for the buy and sell sides of the selected financial product.

30. The financial products order entry system of claim 21 wherein the calculating component is configured to calculate a maximum order size for each of a respective plurality of selected financial products.

31. The financial products order entry system of claim 21 wherein the maximum order size is calculated, in part, based on a reduction factor.

32. The financial products order entry system of claim 21 wherein the calculated maximum order size is calculated in response to the attempt to submit an order larger than currently implemented buying power limits.

33. A method of calculating a maximum order size in a buying power limited financial products order entry system, the method comprising the steps of:
calculating a maximum order size for a selected financial product based, at least in part, on currently implemented buying power limits, currently held positions and currently open orders.

34. The method of claim 33 wherein a trigger action causes the calculation of the maximum order size and the trigger action further causes the execution of an order using the calculated maximum order size for the selected financial product.

35. The method of claim 33 wherein a first trigger action causes the calculation of the maximum order size and a second trigger action causes the execution of an order using the calculated maximum order size for the selected financial product.

36. The method of claim 33 further including the step of displaying the presently calculated maximum order size for the selected financial product.

37. Computer readable media including computer-executable instructions for calculating a maximum order size in a buying power limited financial products order entry system, the computer-executable instructions causing a system to perform the steps of:
calculating a maximum order size for a selected financial product based, at least in part, on currently implemented buying power limits, currently held positions and currently open orders.

38. The computer readable media of claim 37 further performing the steps of displaying the presently calculated maximum order size for the selected financial product.

39. The computer readable media of claim 37 wherein the maximum order size is calculated, in part, based on a reduction factor.

40. The computer readable media of claim 37 wherein the calculation is triggered in response to an attempt to submit an order larger than currently implemented buying power limits.
